(19) United States
(12) Patent Application Publication
(10) Pub. No.: US 2013/0128915 A1
(43) Pub. Date: May 23, 2013

(54) TEMPERATURE CONTROL ELEMENT FOR HEATING AND RAPIDLY COOLING MEASUREMENT SAMPLES

(71) Applicants: Roland Aschauer, Wien (AT); Ernst Hamann, Schoenberg/Kamp (AT); Philipp Jordan, Wien (AT); Andreas Schwarzmann, Wien (AT)

(72) Inventors: Roland Aschauer, Wien (AT); Ernst Hamann, Schoenberg/Kamp (AT); Philipp Jordan, Wien (AT); Andreas Schwarzmann, Wien (AT)

(21) Appl. No.: 13/814,223

(22) PCT Filed: Aug. 3, 2011
(86) PCT No.: PCT/EP2011/063369

§ 371 Date: Feb. 4, 2013

(30) Foreign Application Priority Data
Aug. 6, 2010 (AT) A1333/2010

(51) Int. Cl. F25B 21/04; G01N 25/52; F25B 49/00

(52) U.S. Cl. CPC F25B 21/04; F25B 49/00; G01N 25/52
USPC 374/8; 219/510; 62/3.2; 165/61; 165/62

(57) ABSTRACT

A temperature control element for a measuring device for controlling the temperature of a measurement sample, comprising first and second heating elements delivering thermal energy to the measurement sample, and control means for controlling the heating of the measurement sample, wherein the first and second heating elements heat the measurement sample until a limit temperature has been reached, and wherein thermal resistivity between the first and second heating elements is increased starting at the limit temperature, and the control means disconnects the contact between the first and second heating elements when the limit temperature is reached. A cooling element withdraws thermal energy, and the control means controls cooling of the measurement sample, wherein thermal energy is withdrawn from measurement sample by bringing the cooling element closer to the shut-off of the first heating element, and interrupting the contact between the cooling element and the shut-off of the first heating element.

### CROSS-REFERENCE TO RELATED APPLICATION(S)

This application is a U.S. National Stage Filing under 35 U.S.C. 371 from International Patent Application Serial No. PCT/EP2011/063369, filed on Aug. 3, 2011, and published on Feb. 9, 2012, as WO 2012/017009A1, which claims the benefit of priority to Austrian Patent Application No. A 1333/2010, filed on Aug. 6, 2010, the contents of each of which are hereby incorporated by reference in their entireties.

### BACKGROUND

1. Field

The invention relates to a temperature control element for a measurement device and for temperature controlling a measurement sample comprising a first heating element, which is designed to deliver thermal energy to the measurement sample, and a second heating element, which is designed to deliver thermal energy to the measurement sample by heat conduction via the first heating element, and comprising control means for controlling the heating of the measurement sample, wherein the first heating element and additionally the second heating element are provided for heating the measurement sample until a limit temperature has been reached and wherein the thermal resistivity between the first heating element and the second heating element is increased starting at the limit temperature.

The temperature further relates to a temperature control method for a measurement device for temperature controlling a measurement sample, wherein the following procedural steps are carried out: heating the measurement sample with a first heating element and additionally a second heating element; measurement at the measurement sample.

2. Background

The document EP 0 540 886 A2 discloses such a temperature control element for heating measurement samples and such a temperature control method, wherein such a temperature control element is provided for, e.g., flash point measurement devices. The known temperature control element is made of a plat-like Peltier element and an electrically driven heating plate, wherein there is provided between the two plates a chamber filled with liquid. A Peltier element may be used for heating as well as cooling, wherein a certain limit temperature must not be exceeded in order to prevent thermal destruction of the Peltier element. By means of the Peltier element the measurement sample may be temperature controlled, this is heated and cooled or kept at a temperature, respectively, within a defined temperature range. If the measurement sample, however, is to be heated beyond the limit temperature, then the Peltier element must be thermally decoupled in order to prevent damage thereto.

In the known temperature control element the liquid that is provided in the chamber has a boiling point, which is lower than the limit temperature. If the heating plate heats the measurement sample, and thus also the liquid and the Peltier element, up to the boiling temperature of the liquid, then later the liquid will evaporate and concentrate in an expansion vessel. Because of this, the thermal resistivity between the plates increases and thermally decouples the Peltier element from the heating plate. Then the heating plate may heat the measurement sample up to high temperatures above the limit temperature in order to carry out the measurement at the measurement sample.

After the measurement process, the measurement sample and the temperature control element have to cool down before the measurement sample can be removed from the flash point measurement device in order to perform the next flash point measurement. During the cooling process, following falling below the condensation temperature of the liquid, the chamber is refilled with the liquid and the Peltier element is thermally coupled with the heating plate and the measurement sample.

In the known temperature control element it has been proven to be a disadvantage that the cooling process lasts such a long time, during which the flash point measurement device cannot be used.

It has further been proven to be disadvantageous that the liquid has a relatively large thermal resistivity that cannot be neglected which is why heat conduction from the Peltier element via the liquid and the first heating plate to the measurement sample does not function very effectively. Hence, there is not obtained high efficiency of the Peltier element in cooling and heating the measurement sample.

It has proven to be a further disadvantage that also at temperatures above the limit temperature, with evaporated liquid in the chamber, there is still existent heat conduction between the Peltier element and the first heating plate. In the known temperature control element, hence, there does not take place a complete thermal decoupling, which is disadvantageous.

It has been demonstrated to be an additional disadvantage that the chamber may leak rather easily due to the thermal strain, whereupon the liquid may exit into the measurement device and air enters the chamber so that the further function will be extremely restricted.

Therefore, various aspects of the below-described embodiments provide a temperature control element and a method for temperature controlling, in which the above mentioned disadvantages are prevented.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a temperature control element for a measurement device for temperature controlling a measurement sample (MP) is provided, comprising: a first heating element designed to deliver thermal energy to a measurement sample (MP); a second heating element designed to deliver thermal energy to the measurement sample (MP) by means of heat conduction via the first heating element; and a control means for controlling a heating of the measurement sample (MP), wherein the first heating element and the second heating element are provided for heating the measurement sample until a limit temperature (GT) has been reached and wherein a thermal resistivity between the first heating element and the second heating element is increased starting at a limit temperature (GT), wherein the control means are designed to mechanically disconnect a contact between the first heating element and the second heating element when the limit temperature (GT) has been reached and there is a cooling element for withdrawing thermal energy, and the control means are designed to control a cooling of the measurement sample (MP), wherein thermal energy is withdrawn from the measurement sample (MP) by bringing the cooling element closer to a shut-off of the first heating element and by bringing the cooling element into discontinuous contact with the shut-off of the first heating element.

In another aspect of the disclosed embodiments, a flash point measurement device for measuring a flash point of measurement samples (MP) is provided, further comprising a temperature control element according to above.

In yet another aspect of the disclosed embodiments, a temperature control method for a measurement device for temperature controlling a measurement sample (MP) is provided, comprising: heating a measurement sample (MP) with a first heating element and a second heating element; measuring at the measurement sample (MP), comprising the steps of: disconnecting a mechanical contact between the first heating element and the second heating element if a limit temperature is exceeded when heating the measurement sample (MP); and cooling the measurement sample (MP) by bringing a cooling element closer to a shut-off of the first heating element to reduce a thermal resistivity between the cooling element and the first heating element for withdrawing thermal energy from the measurement sample (MP), wherein a distance between the cooling element and the first heating element is changed in regard to time.

### BRIEF DESCRIPTION OF THE DRAWING

FIG. 1 shows a flash point measurement device having a temperature control element.

FIG. 2 schematically shows the temperature control element while heating the measurement sample underneath the limit temperature.

FIG. 3 schematically shows the temperature control element while cooling the measurement sample after having reached the limit temperature.

FIG. 4 shows temperature curves and control signals when heating and when cooling the measurement sample.

FIG. 5 shows three temperature curves when heating and when cooling the measurement sample.

### DETAILED DESCRIPTION

Various above-mentioned problems are solved in a temperature control element by the fact that the control means are designed to mechanically disconnect the contact between the first heating element and the second heating element starting when the limit temperature has been reached and that there is provided a cooling element for withdrawing thermal energy, and that the control means are designed to control the cooling of the measurement sample, wherein thermal energy is withdrawn from the measurement sample by bringing the cooling element closer to the first heating element and by bringing the cooling element into discontinuous contact with the first heating element.

An exemplary temperature control method comprises the following procedural steps: disconnecting the mechanical contact between the first heating element and the second heating element, if a limit temperature is exceeded in heating the measurement sample; cooling the measurement sample by bringing a cooling element closer to the first heating element in order to reduce the thermal resistivity between cooling element and first heating element for withdrawing thermal energy from the measurement sample, wherein the distance between cooling element and first heating element is changed in regard to time.

By disconnecting the mechanical contact between the heating elements starting at the limit temperature, the thermal resistivity between the heating elements becomes very large, which is why starting at the limit temperature there will be transmitted from the first heating element to the second heating element virtually no heat. This will advantageously guarantee that the second heating element is not thermally damaged.

By bringing the cooling element in the cooling process closer to the first heating plate, the thermal resistivity between the cooling element and the first heating plate decreases, which is why the first heating plate and consequently also the measurement sample are cooled down. When cooling, the cooling element may be positioned in a small distance to the first heating plate, wherein the air-filled distance between the two plates will determine the thermal resistivity. The distance is dimensioned such that the thermal resistivity is small enough for the cooling element really cooling the first heating plate. Simultaneously, the distance is chosen large enough so that the thermal resistivity is large enough to prevent heating of the cooling element above the limit temperature by way of too rapid absorption of thermal energy by the first heating plate.

The cooling element is brought into intermittent mechanical contact with the first heating plate, which is why the first heating plate cools down rather rapidly and the cooling element heats rather rapidly. The cooling element will be lifted from the first heating plate, controlled by temperature or time, upon which the cooling element is allowed to cool down before it is brought into contact with the first heating plate again.

Hereby, there is obtained the advantage that the cooling element may be used immediately after the measurement at the measurement sample, this is at temperatures far above the limit temperature of the cooling element, in order to cool the first heating element and thus also to cool the measurement sample. As the temperature control element omits using liquids, there is given improved operational safety.

Further advantageous embodiments of the inventive temperature control element and of the temperature control method will be explained in the following by way of the Figures.

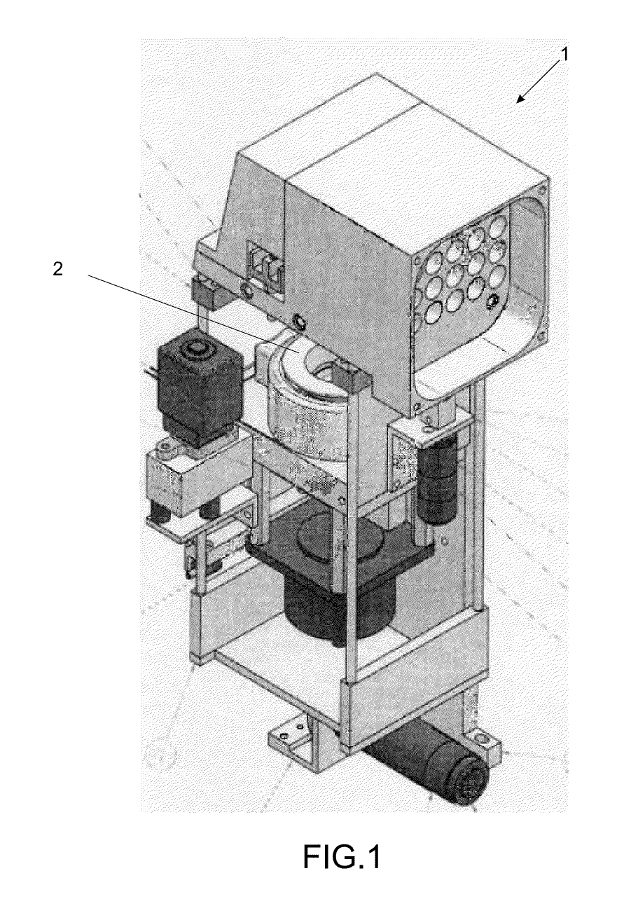

FIG. 1 shows a flash point measurement device 1 having a dish 2 into which a measurement sample MP may be introduced. By means of the flash point measurement device 1 it is possible, e.g., to measure the flash point of oil, petrol and other liquids. The flash point of oils is in general in the temperature range of 180° to 250°, which is why the oil is heated in order to measure the flash point, for the time being, to 180° C. and then further heated at a constant increase rate under periodical impregnation of an ignition spark.

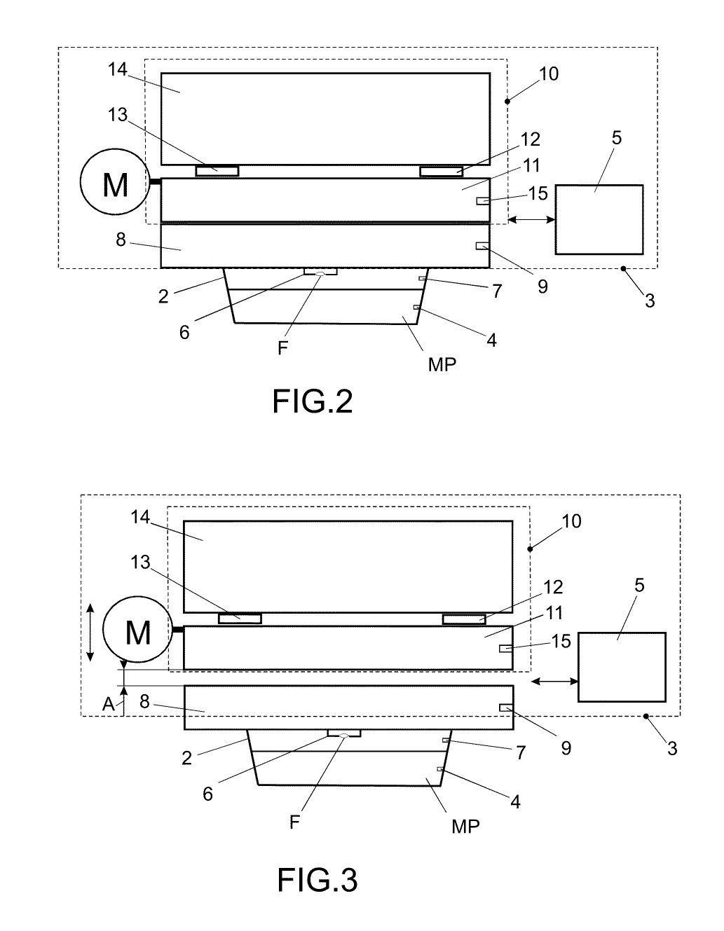

In FIG. 2 the set-up of a temperature control element 3 of the flash point measurement device 1 is symbolically depicted, by means of which the measurement sample MP provided in the dish 2 is heated. A first temperature sensor 4 in the dish 2 measures the temperature T of the measurement sample MP. Control means 5 of the flash point measurement device 1 are provided with the measurement values of the various sensors of the flash point measurement device 1, and the control means 5 are adapted to control the heating of the measurement sample MP, the measurement at the measurement sample MP and the cooling of the measurement sample MP, which will be explained in greater detail in the following.

The flash point measurement device 1 further has a spark emitter 6, which is adapted to be controlled by the control device 5 to emit a spark F. While the measurement sample MP is continuously being heated, per each ° C. of temperature increase there will be examined using the spark F whether the flash point temperature of the measurement sample MP has already been reached. Upon reaching the flash point temperature of the measurement sample MP, there is formed in the dish 2 above the liquid level of the measurement sample MP a flammable mixture that is ignited by the spark F. The flame is detected by a sensor 7, and the control means 5 then store the current temperature of the first temperature sensor 4 as the flash point temperature of the measurement sample MP. Subsequently, the measurement sample MP has to be cooled again by the temperature control element 3, the setup and working principle of which will be explained in greater detail in the following.

The temperature control element 3 has a first heating element 8, which is formed by a brass plate having electrically driven heating rods. At the first heating element 8, there is provided a second temperature sensor 9, by means of which the control means 5 will measure the current temperature T of the first heating element 8. The first heating element 8 is arranged directly above the dish 2, which is why thermal energy is transmitted from the first heating element 8 to the measurement sample MP.

The temperature control element 3 further has a second heating element 10, which is formed by a further brass plate 11 and two Peltier elements 12 and 13 and a cooling body 14 including fan. The Peltier elements 12 and 13 may be used for heating as well as for cooling, wherein a damage temperature of the Peltier elements 12 and 13 must not be exceeded in order to prevent thermal destruction of the Peltier elements 12 and 13. In the data sheet of the Peltier elements 12 and 13 according to the exemplary embodiment, there is listed a damage temperature of 120° C. The control means 5 monitor the temperature T of the Peltier elements 12 and 13 by means of a third temperature sensor 15.

The temperature control element 3 further has a motor M including lifting mechanism, by means of which the brass plate of the first heating element 8 may be placed onto the brass plate 11 of the second heating element 10, or be brought in direct mechanical contact therewith, respectively, and by means of which the brass plates may be positioned spaced apart from each other by a distance A. In this way, the thermal resistivity between the first heating element 8 and the second heating element 10, in addition also forming a cooling element, is changed.

In order to guarantee heating and rapid cooling of the measurement sample MP, the control means 5 for controlling the temperature control element 3 are adapted according to the temperature control method described in the following. In order to guarantee rapid heating of a measurement sample MP introduced in the flash point measurement device 1, the control means 5 will control the motor M in order to bring the second heating element 10 in immediate mechanical contact with the first heating element 8. Subsequently, the control means 5 will control both heating elements 8 and 10 to heat. The thermal energy generated by the second heating element 10 is transmitted from the brass plate 11 to the brass plate of the first heating element 8 and from there to the measurement sample MP. At the same time, the heating rods of the first heating element 8 also heat the brass plate of the first heating element 8, by means of which the measurement sample M is additionally and thus especially rapidly heated.

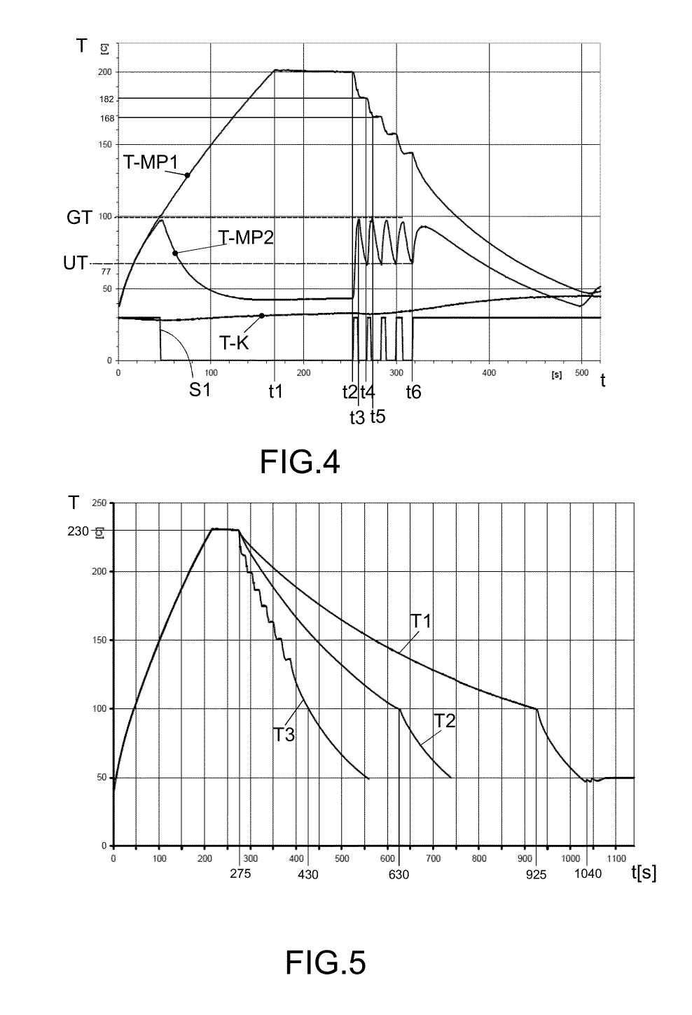

In FIG. 4, the temperature course T-MP1 of the temperature T of the measurement plate of the first heating element 8 that is measured by the second temperature sensor 9 and the temperature course T-MP2 of the temperature T of the measurement plate 11 of the second heating element 10 that is measured by the third temperature sensor 15 is illustrated over the time t. As the damage temperature of the Peltier elements 12 and 13 is 120° C., above which there is given the danger of damage, the temperature of 100° C. was determined as limit temperature. Upon reaching the limit temperature GT, the control means 5 will control the motor M by means of a control signal S1 depicted in FIG. 4 in order to lift the second heating element 10 from the first heating element 8 and to position it in the distance A, as is illustrated in FIG. 3. According to the exemplary embodiment, the distance A has a length of 3 mm, which is sufficiently large so that virtually no thermal conduction between the brass plates takes place. At the same time, upon reaching the limit temperature GT, the control means 5 switch the Peltier elements 12 and 13 from heating operation to cooling operation, which is why the temperature T of the brass plate 11 of the second heating element 10 decreases to less than 50° C. relatively rapidly, as is visible in the temperature course T-MP2 in FIG. 4. The heating rods of the first heating element 8 heat the measurement sample MP beyond the limit temperature GT, as is visible in the temperature course T-MP1 in FIG. 4. At a temperature of 200° C., the flash point of the measurement sample MP is detected, which is why the measurement is ended at the point of time t1 and the cooling process of the measurement sample MP starts at a point of time t2. Subsequently, the control means 5 transmit the control signal S1 to the motor M, which brings the second heating element 10 again in mechanical contact with the first heating element 8. As the brass plate 11 of the second heating element 10 is cooled to 40° C. by the Peltier elements 12 and 13, the brass plate 11 withdraws very quickly a lot of thermal energy from the 200° C. brass plate of the first heating element 8 and cools it up to the point of time t3 to 182° C. At the point of time t3, the brass plate 11—in spite of continuous cooling by the Peltier elements 12 and 13—has heated up to the limit temperature GT, which is why the control means 5 again transmit the control signal S1 to the motor M and lift the second heating element 10 from the first heating element .

Hereby there is obtained the advantage that the already cooled brass plate 11 of the second heating element 10 or of the cooling element cools the brass plate of the first heating element 8 and thus also the measurement sample MP very quickly from 200° C. to 182° C. By lifting the cooling element upon reaching the limit temperature GT, there is additionally guaranteed that the Peltier elements 12 and 13 will not suffer any thermal damage, as the temperature of the brass plate 11 will not exceed 100° C. at any point of time.

From the point of time t4 on, the cooling element is again thermally decoupled from the first heating element 8, which is why the Peltier elements 12 and 13 relatively quickly cool the brass plate 11, whereupon the brass plate 11 reaches a lower limit temperature UT of 77° C. at a point of time t4. At this point of time t4, the control means 5 again transmit the control signal S1 to the motor M, whereupon the cooling element is again brought into mechanical contact with the first heating element 8. Until a point of time t5, the temperature of the brass plate of the first heating elements decreases to 168° C., at which point of time t5 the cooling element has again reached the limit temperature GT and is again lifted from the first heating element 8.

According to the exemplary embodiment the cooling element 10 is placed onto the first heating element 8 and lifted therefrom in a temperature-controlled way. By this incremental cooling of the brass plate of the first heating element 8, which is connected with the measurement sample MP via heat conduction, there is advantageously provided especially rapid cooling of the first heating element 8 and the measurement sample MP.

From the point of time t6 on, the cooling capacity of the two Peltier elements 12 and 13 is sufficient so that the temperature T of the brass plate 11 will not reach the limit temperature GT any more, which is why the cooling element 10 will remain continuously in mechanical contact with the first heating plate 8 and cool it below 50° C. from this point of time on. Thereupon, the measurement sample MP may be removed from the flash point measurement device 1.

In FIG. 5, there are depicted temperature curves of the temperature T of the brass plate of the first heating element 8, which illustrate the effect of different cooling methods. The uppermost temperature curve T1 shows the course of the temperature T of the first heating element 8, and thus essentially also the course of the temperature T of the measurement sample MP, if cooling is carried out exclusively by means of thermal convection in a lifted or shut-off, respectively, cooling element and shut-off heating elements. In this case, cooling from 230° C. to 100° C. last nearly 11 minutes (925 s−275 s=650 seconds) in order to subsequently cool with the cooling element 10 that is arranged onto the first heating element 8 within rather short 2 minutes (1040 s−925 s=1125 seconds) to 50° C.

The middle temperature curve T2 shows the course of the temperature T of the first heating element 8, and thus essentially also the course of the temperature T of the measurement sample MP, if the cooling element 10 is positioned spaced apart from the first heating element 8 by a distance A of 0.1 mm. Across this very small air gap, there takes place a really intensive thermal convection, which is why the air gap forms a relatively low thermal resistivity. The thermal resistivity, however, is large enough to prevent that the brass plate 11 of the cooling element 10 heats up to the limit temperature GT, which is why the distance A is kept constant throughout the entire cooling process. In this case, when using the cooling element 10 that is brought closer to but not into mechanical contact with the first heating element 8, cooling from 230° C. to 100° C. will last only mere 6 minutes (630 s−275 s=355 seconds). By bringing the cooling element 10 closer to the first heating element 8, it was possible to cool the first heating element 8 and the measurement sample MP from 230° C. to 100° C. within half of the period of time, which is why it was possible to perform essentially more flash point measurements per day using the flash point measurement device 1 than would be possible using only natural convection for cooling. Hereby, there is obtained a further inventive possibility to cool the first heating plate 8 relatively quickly. The advantage of this embodiment variant is provided by the fact that the Peltier elements need not undergo fast temperature fluctuations, prolonging the service life of the Peltier elements.

The lower temperature curve T3 shows the course of the temperature T of the first heating element, and thus essentially also the course of the temperature of the measurement sample MP, if the cooling element 10 is brought into mechanical contact with the first heating element 8 in a temperature-controlled way, as this has been described above by way of FIG. 4. In this case, cooling from 230° C. to 100° C. will last only 2.58 minutes (430 s−275 s=155 seconds). In this way, the number of the flash point measurements per day using the flash point measurement device 1 may advantageously be further increased.

According to another exemplary embodiment, the control means 5 will control the motor M not in a temperature-controlled but rather a time-controlled way to mechanically contact and again lift the cooling element 10 from the first heating element 8. This is possible if the physical parameters of the temperature control element 3 and the measurement sample MP remain essentially unchanged. In this connection, for example, the thickness of the brass plate or the heat storage capacity thereof, respectively, and the cooling performance of the Peltier elements 12 and 13 are important as physical parameters of the temperature control element 3. In this case, there can be determined, either empirically or calculatorily, the period of time over which the cooling element 10 may be safely placed onto the first heating element 8, without reaching or even exceeding the damage temperature of the Peltier elements. As safety reserves have to be taken into consideration in this case, the cooling element 10 may be placed onto the first heating element 8 only for shorter periods of time than in the case of temperature control. In a time-controlled temperature control element, however, the third temperature sensor may be omitted, which is why hereby there is obtained a cost-effective solution.

By using the Peltier elements as second heating element, there is obtained the advantage that these may also be used for cooling and that a separate cooling element may be omitted.

The optimal distance A for the exemplary embodiment having a constant distance A throughout the cooling process and the optimal distance A for the exemplary embodiment including discontinuous mechanical contact of the cooling element with the first heating element are dependent on several parameters. Precedingly, there has already been referred to relevant physical parameters of the temperature control element, wherein, however, there are existent also further parameters like atmospheric humidity or minimally acceptable thermal resistivity in the case of a lifted cooling element. According to the exemplary embodiment, thus the distance A of 0.5 mm or 5 mm may be optimal for the application.

By making provision of the cooling body 14, there is obtained the advantage that the Peltier elements work especially effectively. In FIG. 4 there is illustrated the only very slight increase of the temperature T of the cooling body as temperature course T-K.

There may be noted that there may also be provided three, five or ten Peltier elements in one temperature control element.

There may be noted that also other cooling elements working in another cooling principle may be provided in a temperature control element.

1. A temperature control element for a measurement device for temperature controlling a measurement sample, comprising:
a first heating element designed to deliver thermal energy to the a measurement sample (MP);
a second heating element designed to deliver thermal energy to the measurement sample by means of heat conduction via the first heating element; and
a control means for controlling a heating of the measurement sample (MP), wherein the first heating element and the second heating element are provided for heating the measurement sample until a limit temperature (GT) has been reached and wherein a thermal resistivity between the first heating element and the second heating element is increased starting at a limit temperature (GT), wherein the control means are designed to mechanically disconnect a contact between the first heating element and the second heating element when the limit temperature (GT) has been reached and there is a cooling element for withdrawing thermal energy, and the control means are designed to control a cooling of the measurement sample (MP), wherein thermal energy is withdrawn from the measurement sample (MP) by bringing the cooling element closer to a shut-off of the first heating element and by bringing the cooling element into discontinuous contact with the shut-off of the first heating element.

2. The temperature control element according to claim 1, wherein the cooling element is formed by the second heating element and by a Peltier element.

3. The temperature control element according to claim 1, wherein the first heating element and the second heating element are formed as plates and there are transport means (M), which are controlled by the control means, to contact the plate surfaces of the heating elements and to disconnect the contact by a plate distance (A), wherein the plate distance (A) is wider than 2 millimetres.

4. The temperature control element according to claim 1, wherein the second heating element and the first heating element have a temperature sensor, wherein the limit temperature (GT) is measured by the temperature sensor of the second heating element, and that the control means are designed to discontinuously contact the cooling element with the first heating element in a temperature-controlled way in order to prevent overheating of the cooling element beyond the limit temperature.

5. The temperature control element according to claim 1, wherein the control means discontinuously contacts the cooling element with the first heating element in a time-controlled way.

6. The temperature control element according to claim 1, further comprising a cooling body arranged in heat conducting contact with the cooling element.

7. A flash point measurement device for measuring a flash point of measurement samples (MP), further comprising a temperature control element according to claim 1.

8. A temperature control method for a measurement device for temperature controlling a measurement sample (MP), comprising:
heating a measurement sample (MP) with a first heating element and a second heating element;
measuring at the measurement sample (MP), comprising the steps of:
disconnecting a mechanical contact between the first heating element and the second heating element if a limit temperature is exceeded when heating the measurement sample (MP); and
cooling the measurement sample (MP) by bringing a cooling element closer to a shut-off of the first heating element to reduce a thermal resistivity between the cooling element and the first heating element for withdrawing thermal energy from the measurement sample (MP), wherein a distance between the cooling element and the first heating element is changed in regard to time.

9. The temperature control method according to claim 8, wherein the cooling element is brought into heat conducting contact with the first heating element until the cooling element has reached a limit temperature (GT), upon which the heat conducting contact is disconnected until a lower limit temperature (UT) has been reached and the cooling element is again brought into heat conducting contact with the first heating element.

10. The temperature control method according to claim 8, wherein the cooling element is brought into heat conducting contact with the first heating element for determined periods of time.

11. The temperature control method according to claim 8, wherein the cooling element is positioned in a constant distance with stable thermal resistivity to the first heating element after having been brought closer to the first heating element in the cooling process.

12. The temperature control element according to claim 2, wherein the first heating element and the second heating element are formed as plates and there are transport means (M), which are controlled by the control means, to contact the plate surfaces of the heating elements and to disconnect the contact by a plate distance (A), wherein the plate distance (A) is wider than 2 millimetres.

13. The temperature control element according to claim 2, wherein the second heating element and the first heating element have a temperature sensor, wherein the limit temperature (GT) is measured by the temperature sensor of the second heating element, and that the control means are designed to discontinuously contact the cooling element with the first heating element in a temperature-controlled way in order to prevent overheating of the cooling element beyond the limit temperature (GT).

14. The temperature control element according to claim 3, wherein the second heating element and the first heating element have a temperature sensor, wherein the limit temperature (GT) is measured by the temperature sensor of the second heating element, and that the control means are designed to discontinuously contact the cooling element with the first heating element in a temperature-controlled way in order to prevent overheating of the cooling element beyond the limit temperature (GT).

15. The temperature control element according to claim 2, wherein the control means discontinuously contacts the cooling element with the first heating element in a time-controlled way.

16. The temperature control element according to claim 3, wherein the control means discontinuously contacts the cooling element with the first heating element in a time-controlled way.

17. The temperature control element according to claim 2, further comprising a cooling body arranged in heat conducting contact with the cooling element.

18. The temperature control element according to claim 3, further comprising a cooling body arranged in heat conducting contact with the cooling element.

19. A flash point measurement device for measuring a flash point of measurement samples (MP), further comprising a temperature control element according to claim 2.

20. A flash point measurement device for measuring a flash point of measurement samples (MP), further comprising a temperature control element according to claim 3.
